(19) United States
(12) Patent Application Publication
(10) Pub. No.: US 2013/0320088 A1
(43) Pub. Date: Dec. 5, 2013

(54) SUBSCRIBER IDENTITY MODULE HAVING FUNCTION OF RADIO FREQUENCY IDENTIFICATION READER AND SUBSCRIBER IDENTITY MODULE WITH ANTENNA

(71) Applicants: Hsin-Lung Lin, Hsinchu (TW); Chia-Yu Pan, Taichung (TW)

(72) Inventors: Hsin-Lung Lin, Hsinchu (TW); Chia-Yu Pan, Taichung (TW)

(73) Assignee: SMART APPROACH CO., LTD., Hsinchu (TW)

(21) Appl. No.: 13/482,893

(22) Filed: May 29, 2012

(51) Int. Cl. G06K 19/067; G06K 7/06

(52) U.S. Cl. 235/441; 235/492

(57) ABSTRACT

A subscriber identity module having function of radio frequency identification (RFID) reader includes a card slot, a base, an identification module, an identification chip, and a plurality of reader pads. The card slot has a plurality of phone pins and a plurality of reader pins. The base is disposed in the card slot and has a first accommodating area and a second accommodating area. The identification module is disposed in the first accommodating area and is electrically connected to the phone pins. The identification chip is disposed in the second accommodating area. The reader pads are disposed on the base and are adjacent to the identification chip, and the reader pads are electrically connected to the identification chip and the phone pads.

### BACKGROUND

1. Technical Field

The present disclosure relates to a subscriber identity module (SIM), and more particularly to a SIM having function of radio frequency identification (RFID) reader and a SIM with an antenna.

2. Related Art

A SIM is a smart card capable of storing data and being accessed based on an identification command. If it is an error identification command, the SIM card rejects the accessing of data from a user. That is, a user must input a right identification command to use the data stored in the SIM. For example, when a SIM card is used in a mobile phone, a user must input the correct password to unlock the SIM and then uses the phone for communications. Therefore, a SIM card can be used as a device for indentifying particular users.

With development of wireless communications, manufacturers have combined a SIM card with RFID. The RFID is a radio communication technology, and it is composed of a reader, a transponder, and middleware & system integration. Therefore, a SIM card integrated with the RFID technology can be functioned like a RFID tag.

A reader comprises a signal processing unit and a wireless communication unit. The signal processing unit is used for processing transmitted signals and received signals. The wireless communication unit is used for wirelessly transmitting and receiving signals. A transponder comprises an electronic chip and an antenna. The electronic chip is provided for accessing of data and the antenna is used for wirelessly transmitting and receiving signals. When the reader transmits a radio wave with a specific frequency to the transponder, the radio wave is converted to a current signal by the antenna to drive a circuit of the electronic chip so that the data stored in the chip can be transmitted back to the reader. The middleware & system integration is a software system used between the user and the reader for collecting, processing and responding the data received by the reader to the user. After the RFID antenna is electrically connected to the identification chip, the identification data in the SIM card can be read by the identification chip and then is transmitted back to the reader, and therefore the SIM card can be functioned like a RFID tag.

However, when a SIM card is installed in a mobile phone, in order to obtain data in the SIM card, a user can only transmit information to the reader by connection between the inner chip of the mobile phone and the reader. That is, the SIM card cannot be used as a reader to identify an external chip, such as smart card. Therefore, it is not convenient to use such a SIM card.

### SUMMARY

In one aspect, a subscriber identity module (SIM) having function of radio frequency identification (RFID) reader comprises: a card slot having phone pins and reader pins; a base disposed in the card slot, the base having a first accommodating area and a second accommodating area; an identification module disposed in the first accommodating area and being electrically connected to the phone pins; an identification chip disposed in the second accommodating area; and a plurality of reader pads disposed on the second accommodating area and being adjacent and electrically connected to the identification chip, and the plurality of reader pins being electrically connected to the identification chip through the plurality of reader pads.

In another aspect, a subscriber identity module (SIM) with an antenna comprises: a card slot having phone pins and reader pins; a soft board; an antenna coil disposed at an end of the soft board; a base adhered on an end of the soft board opposite to the end where the antenna coil being disposed, and the base disposed in the card slot and having a first accommodating area and a second accommodating area; an identification module disposed in the first accommodating area and being electrically connected to the plurality of phone pins; an identification chip disposed in the second accommodating area; and the plurality of reader pads disposed on the base and being adjacent and electrically connected to the identification chip, and the plurality of reader pins being electrically connected to the identification chip through the plurality of reader pads.

### BRIEF DESCRIPTION OF THE DRAWINGS

The present disclosure will become more fully understood from the detailed description given herein below for illustration only, and thus are not limitative of the present disclosure, and wherein:

FIG. 1 is a top view of a SIM with an antenna according to an embodiment of the disclosure;

FIG. 2 is a bottom view of a SIM with an antenna according to an embodiment of the disclosure;

FIG. 3 is a side view of a SIM with an antenna according to an embodiment of the disclosure; and

FIG. 4 is an exploded view of a SIM with an antenna according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

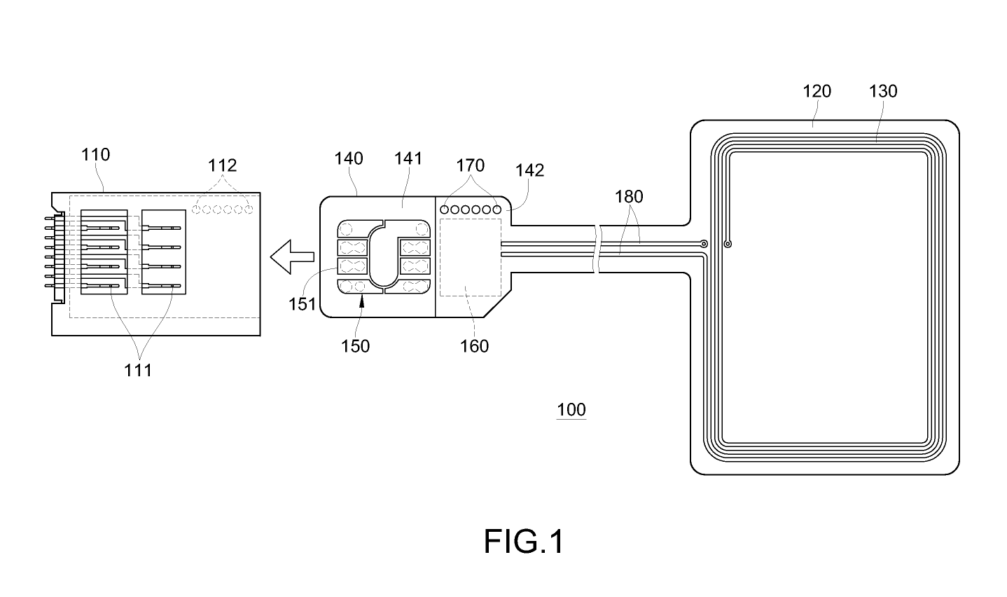

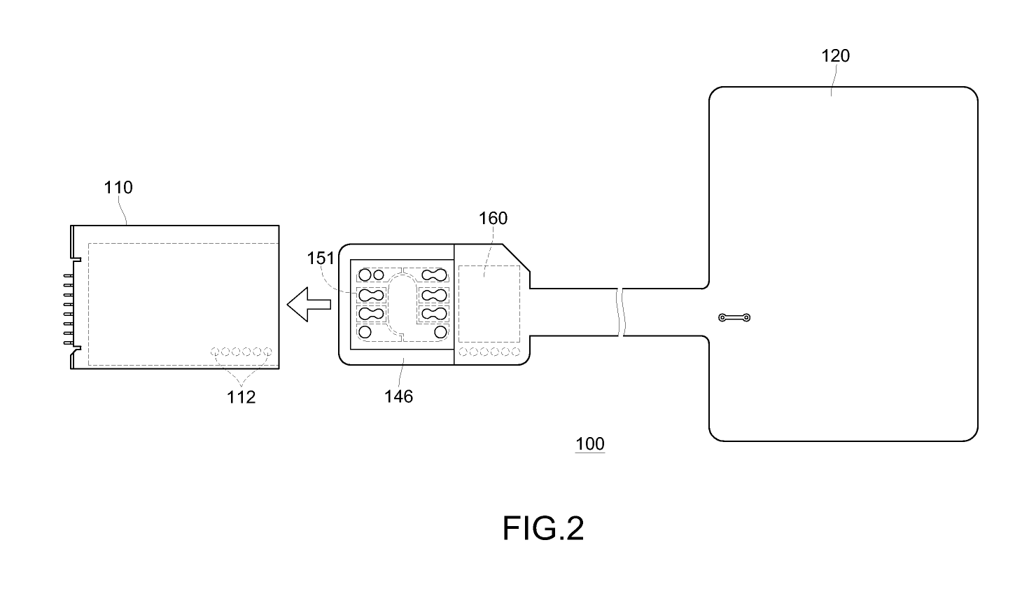

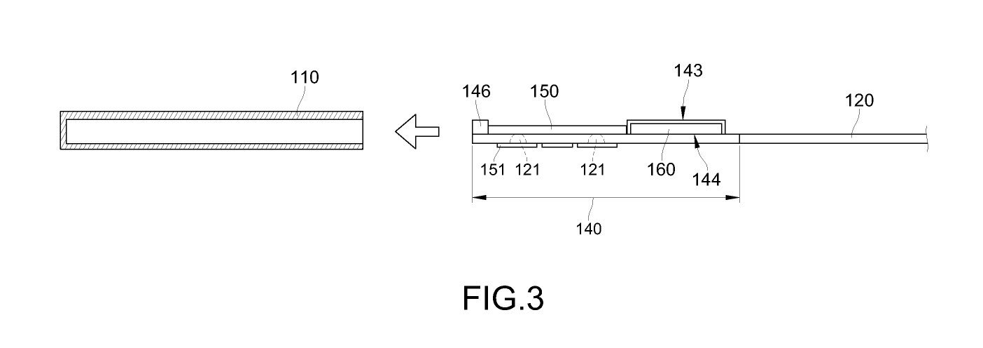

FIGS. 1 and 2 are a top view and a bottom view and a sectional view of a SIM without a identification module according to one embodiment of the present disclosure and FIG. 3 is a sectional view of the SIM with the identification module. The SIM 100 with an antenna according to this embodiment replacing a common SIM is adapted to be disposed in a mobile phone. Furthermore, the SIM 100 with an antenna has functions of radio frequency identification (RFID) or near field communication (NFC), and it further has function of RFID reader.

The SIM 100 comprises a card slot 110, a soft board 120, an antenna coil 130, a base 140, an identification module 150, an identification chip 160 and a plurality of reader pads 170. The card slot 110 has a plurality of phone pins 111 and a plurality of reader pins 112. The soft board 120 can be a flexible substrate such as a common flexible printed circuit (FPC).

The antenna coil 130 is disposed at an end of the soft board 120 and the antenna coil 130 can be printed on the soft board 120, but the disclosure is not limited this way. Furthermore, the antenna coil 130 can be a radio frequency antenna or a NFC antenna.

The base 140 comprise an article 146 and a portion of the soft bard 120 on which the article 146 is placed. The article 146 which is made of, for example plastic or metal is adhered on an end of the soft board 120 opposite to the end where the antenna coil 130 is disposed. In other words, the card slot 110 and the antenna coil 130 are respectively disposed at the two opposite ends of the soft board 120. In this embodiment, the base 140 can be adhered on the soft board 120 by means of thermo-compression or agglutination, but the disclosure is not limited this way. The base 140 can be disposed (inserted) in the card slot 110 (as shown by the arrow in FIG. 1). The base 140 has a first accommodating area 141 and a second accommodating area 142 for accommodating different objects.

The identification module 150 is disposed in the first accommodating area 141 and exposed on a first surface 143 of the base 140. In other words, the identification module 150 is not covered by the first surface 143 of the base 140. In this embodiment, the portion of the soft bard 120 on which the article 146 is placed comprises phone pads 151 and both-side conducted metal convex points 121. The phone pads 151 are formed on a side of the soft board 120. The both-side conducted metal convex points 121 pass through the base, so that one end of each metal convex point 121 is electrically connected to one of the phone pad 151 and the other end of each metal convex point 121 is electrically connected to a pad of the identification module 150. The phone pads 151 can be disposed corresponding to the phone pins 111 of the card slot 110, for example, by way of one-to-one, so that when the base 140 is inserted in the card slot 110, the identification module 150 can be electrically connected to the phone pins 111 through the metal convex points 121 and the phone pads 151.

The article 146 is used for accurately controlling the location of the identification module 150 and enhancing the structural strength of the base 140. The base 140 further comprises clamp grooves disposed on the first accommodating area 141 for clamping the identification module 150 so that the identification module 150 can be fixed in the first accommodating area 141.

The identification chip 160 is disposed in the second accommodating area 142. The identification chip 160 is disposed between the first surface 143 and the opposite second surface 144. In this embodiment, the identification chip 160 can be disposed on the soft board 120 by chip on board (COB) process or chip on film (COF) process, but the disclosure is not limited this way. Additionally, in this embodiment the identification chip 160 in the second accommodating area 142 can be disposed between the first surface 143 and the second surface 144 by a plastic filling procedure. In this case, the identification chip 160 is covered by the first surface 143 of the base 140.

The plurality of reader pads 170 electrically connected to the identification chip 160 are disposed on the soft board 120 in the second accommodating area 142 and are adjacent to the identification chip 160. Furthermore, the reader pads 170 can be disposed corresponding to the reader pins 112, for example, by way of one-to-one So that when the base 140 is inserted in the card slot 110, the reader pins 112 can be electrically connected to the reader pads 170. In this embodiment, the reader pins 112 can be, for example, pogo pins, and the reader pads 170 can be, for example, metal pads. In another embodiment, the reader pins 112 can be, for example, metal convex points, and the reader pads 170 can be, for example, metal pads.

The SIM 100 further comprises a connection circuit 180, which is disposed on the soft board 120 and is located between the antenna coil 130 and the identification chip 160 so that the antenna coil 130 can be electrically connected to the identification chip 160 via the connection circuit 180. The antenna coil 130 is used for receiving a radio signal sent from a RFID reader and converting the radio signal into a first signal current. Then, the first signal current is transmitted to the identification chip 160 via the connection circuit 180. In the other hand, the antenna coil 130 can send back a second signal current sent from the identification chip 160 and convert the second signal current into another radio signal, which is wirelessly transmitted to the RFID reader.

Further, after the SIM 100 (i.e. the SIM having RFID reader function) receives a command of a mobile phone, the identification chip 160 sends the first signal current, and the antenna coil 130 converts the first signal current into a radio signal. Then, the radio signal is wirelessly transmitted to an external identification chip (e.g. a smart card). Furthermore, the antenna coil 130 receives and converts a radio signal transmitted from the external identification chip. The radio signal is converted into the second signal current which is transmitted to the identification chip 160, and then the second signal current is converted into a digital signal transmitted to the mobile phone. Therefore, the RFID function of the SIM 100 can be achieved.

In this embodiment, the identification module 150 can be, for example, a micro SIM card, and the identification chip 160 can be, for example, a NFC chip. Based on the above configuration, after the card slot 110 is installed in a mobile phone, the processor in the mobile phone can be electrically connected to the identification chip 160 by the phone pins 112 (i.e. pogo pins or metal convex points) and the reader pads 170 (i.e. metal pads) disposed respectively on the card slot 110 and the base 140. Therefore, a mobile phone user can read the data stored in an external identification chip, and the external reader can read data in the identification module 150. In this way, the use convenience of the SIM can be enhanced.

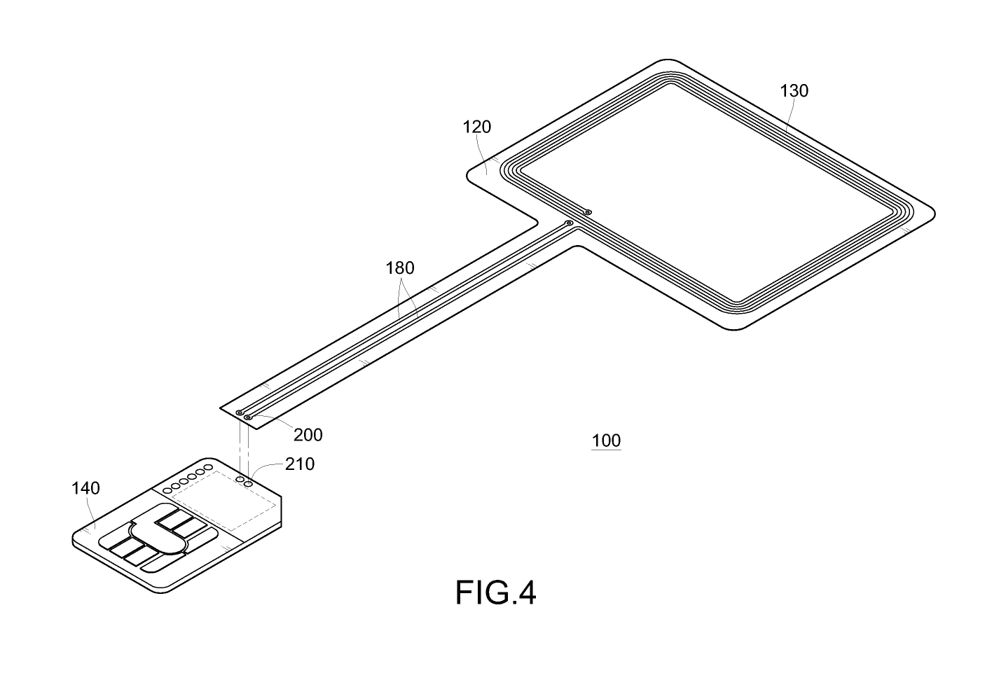

FIG. 4 is an exploded view of the SIM 100 with an antenna according to an embodiment of the present disclosure. In this embodiment, the SIM 100 further comprises an electric connector 200 which is disposed at one end of the soft board 120. The antenna coil 130 is disposed at the other end of the soft board 120 opposite to the electric connector 200. The antenna coil 130 is electrically connected to the electric connector 200 by the connection circuit 180. The electric connector 200 is composed of two metal convex points.

The base 140 further comprises an electric socket 210 which is electrically connected to the identification chip 160. The electric socket 210 is composed of two metal pads. The electric connector 200 is inserted in the electric socket 210 so that the identification chip 160 is electrically connected to the antenna coil 130. More specifically, when the base 140 is assembled with the soft board 120, the metal convex points (i.e. the electric connector 200) on the soft board 120 is inserted into the two metal pads (i.e. the electric socket 210) on the base 140. Then, the base 140 and the soft board 120 are further combined by means of a double-sided adhesive tape, thermo-compression or welding. As a result, the SIM 100 with an antenna in this embodiment can achieve the same effects of aforementioned embodiment for FIGS. 1-3.

In another embodiment, the electric connector 200 can be fixed on the card slot 110, and the location of the electric connector 200 corresponds to the location of the two metal pads (i.e. the electric socket 210) on the base 140. In this case, when the base 140 is inserted in the card slot 110, the electric socket 210 on the base 140 can be electrically connected to the electric connector 200 directly. Therefore, the base 140 and the soft board 120 are not necessarily combined by thermo-compression or welding.

The SIM with RFID reader function and the SIM with an antenna according to the embodiments of the disclosure are configured with a plurality of phone pins disposed on the card slot and a plurality of reader pads disposed on the base. Based on the configuration described above, when the SIM is installed in a mobile phone, the processing unit of the mobile phone can read the data stored in an external identification chip, and in the other hand the data in the identification chip of the SIM can be read by an external reader. Therefore, use convenience of the SIM can be enhanced.

Note that the specifications relating to the above embodiments should be construed as exemplary rather than as limitative of the present disclosure, with many variations and modifications being readily attainable by a person of average skill in the art without departing from the spirit or scope thereof as defined by the appended claims and their legal equivalents.

What is claimed is:

1. A subscriber identity module (SIM) having function of radio frequency identification (RFID) reader, comprising:
a card slot having a plurality of phone pins and a plurality of reader pins;
a base disposed in the card slot, the base having a first accommodating area and a second accommodating area;
an identification module disposed in the first accommodating area and being electrically connected to the plurality of phone pins;
an identification chip disposed in the second accommodating area; and
a plurality of reader pads disposed on the base and being adjacent and connected to the identification chip, and the plurality of reader pins being electrically connected to the identification chip through the plurality of reader pads.

2. The SIM having function of RFID reader as claimed in claim 1, wherein the plurality of phone pins and reader pins are pogo pins and the plurality of reader pads are metal pads.

3. The SIM having function of RFID reader as claimed in claim 1, wherein the plurality of phone pins and reader pins are metal convex points and the plurality of reader pads are metal pads.

4. The SIM having function of RFID reader as claimed in claim 1, wherein the identification module is a micro SIM card and the identification chip is a radio frequency identification chip.

5. A subscriber identity module (SIM) with an antenna, comprising:
a card slot having a plurality of phone pins and a plurality of reader pins;
a soft board;
an antenna coil disposed at an end of the soft board;
a base adhered on an end of the soft board opposite to the end where the antenna coil being disposed, and the base disposed in the card slot and having a first accommodating area and a second accommodating area;
an identification module disposed in the first accommodating area and being electrically connected to the plurality of phone pins;
an identification chip disposed in the second accommodating area; and
a plurality of reader pads disposed on the base and being adjacent and connected to the identification chip, and the plurality of reader pins being electrically connected to the identification chip through the plurality of reader pads.

6. The SIM with an antenna as claimed in claim 5, wherein the plurality of phone pins and reader pins are pogo pins and the plurality of reader pads are metal pads.

7. The SIM with an antenna as claimed in claim 5, wherein the plurality of phone pins and reader pins are metal convex points and the plurality of reader pads are metal pads.

8. The SIM with an antenna as claimed in claim 5, wherein the identification module is a micro SIM card and the identification chip is a radio frequency identification (RFID) chip.

9. The SIM with an antenna as claimed in claim 5, further comprising a connection circuit disposed on the soft board, the connection circuit is disposed between the antenna coil and the identification chip for electrically connecting the antenna coil with the identification module as well as the identification chip.

10. The SIM with an antenna as claimed in claim 5, wherein the antenna coil is a radio frequency antenna or a near field communication (NFC) antenna.
